(19) United States
(12) Patent Application Publication
(10) Pub. No.: US 2002/0191698 A1
(43) Pub. Date: Dec. 19, 2002

(54) Video data CODEC system with low computational complexity

(75) Inventors: Jae-Beom Lee, White Plains, NY (US); Carl Kijang Jung, Fort Lee, NJ (US); Po-Chin Hu, Guttenberg, NJ (US); Eunsoo Shim, Fort Lee, NJ (US)

Correspondence Address: Frank Chau, Esq., F. CHAU & ASSOCIATES, LLP, Suite 501, 1900 Hempstead Turnpike, East Meadow, NY, 11554, US

(73) Assignee: SolidStreaming, Inc.

(21) Appl. No.: 09/882,220

(22) Filed: Jun. 15, 2001

(51) Int. Cl. H04N 7/12

(52) U.S. Cl. 375/240.12; 375/240.15; 375/240.24

(57) ABSTRACT

A method for encoding video data includes the steps of providing video data having a plurality of frames each of which has a plurality of blocks each of which has a predetermined number of pixels, providing a codebook having indices each representing a different pattern, performing an intra-coding process with respect to a first set of frames of the plurality of frames to select from the codebook best match indices for respective blocks of the first set of frames, performing a predictive coding process with respect to a second set of frames of the plurality of frames to obtain codes for respective blocks of the second set of frames, wherein each of the codes has an index-body determined using the best match indices for the blocks of the first set of frames and best match indices selected from the codebook for the blocks of the second set of frames, and performing a bi-directional predictive coding process with respect to a third set of frames of the plurality of frames to obtain codes for respective blocks of the third set of frames, wherein each of the codes has an index-body determined using the best match indices for the blocks of the first and second sets of the frames and best match indices selected from the codebook for the blocks of the third set of frames.

### BACKGROUND OF THE INVENTION

1. Field of the Invention

The present invention relates to a data coding-decoding system, and more particularly, to a system and method of coding and decoding low-bitrate video data using computation with reduced complexity.

2. Discussion of Related Art

Systems for compressing and decompressing audio/video data have been developed to reduce bandwidth requirements and reduce costs in wireless digital communication. Data compression and decompression are generally accomplished by employing data encoding and decoding systems. A data encoding system encodes audio/video data prior to the data transmission, and a data decoding system decodes the encoded data after the data transmission.

An encoder-decoder (CODEC) system for compressing and decompressing multimedia data defines a data unit to perform the data compression and decompression. For example, a data unit of video data may be defined as 4×4 pixels and 16×16 pixels. In the data compression, the primary job of an encoder is to decorelate all the data in a data unit by using a previous set of data, so that only net information is captured to reduce the number of data bits to be transmitted. There are various types of CODEC systems using different decorelation techniques to extract net information. Two of the most important techniques are Discrete Cosine Transform (DCT) and Motion Compensation (MC) that are used for the Moving Picture Experts Group (MPEG) standards. The MPEG standards as well as the DCT and MC techniques are well known in the art, thus a detailed description thereof is omitted.

One of the problems in conventional CODEC techniques including the MPEG standards is that computations with very complex algorithms are required for data compression and decompression. For example, a data decoding system employing the MPEG standards requires 20-40 mega instructions per second (MIPS) for a frame decode. A large amount of power is required for operating 20-40 MIPS. Due to the large amount of power consumption, it is almost impossible to use the conventional CODEC techniques in portable equipments having limitation of battery life, such as wireless hand-phone sets.

Another problem in the conventional CODEC systems, especially techniques employing the MPEG standards, is the variable length coding (VLC) in an erroneous channel. If one VLC for a symbol is broken with an error, it is impossible to locate the position where the next VLC for the next symbol begins. If a bit-stream is ruined by an error, a problem is caused by continuous parsing of the bitstream.

In multimedia communications on a network, video data requires a larger bandwidth between two entities on a network. Thus, transmission of video data on current generation of networks without data compression is difficult. Current generation wireless channels generally have a narrower bandwidth than that of wired network. Thus, conventional CODEC systems can hardly be used for the video data transmission over the narrow bandwidth wireless channels.

Therefore, a need exists for a CODEC system requiring data process algorithms and computation with very low complexity and capable of processing very low bitrate video data. Further, it will be advantageous to provide a CODEC system requiring low power consumption and having capability of transmitting video data over the wireless channels on current generation of networks.

### OBJECTS AND SUMMARY OF THE INVENTION

It is an object of the present invention to provide a CODEC system and method having algorithms with low complexity and thus requiring reduced computational power dissipation.

It is another object of the present invention to provide a CODEC system having error resilience such as when an error occurs in one index the next index can be located. Thus, if some part of bitstream is corrupted through a wireless channel so that either interpretation of a decoder becomes wrong or a decoder will stall, error resilience techniques discover error and recover original symbols and/or bitstreams. Certain error resilience can be done in bitstream level, while other error resilience can be done in algorithm level.

It is a further object of the present invention to provide a CODEC system which employs a compressed codebook for data encoding and decoding so as to have a minimized memory size.

To achieve the above and other objects, the present invention provides a method for encoding video data, which preferably includes providing video data having a plurality of frames each of which has a plurality of blocks, each block having a predetermined number of pixels; providing a codebook having indices each representing a different pattern; performing an intra-coding process with respect to a first set of frames of the plurality of frames to select from the codebook best match indices for respective blocks of the first set of frames; performing a predictive coding process with respect to a second set of frames of the plurality of frames to obtain codes for respective blocks of the second set of frames, wherein each of the codes has an index-body determined using the best match indices for the blocks of the first set of frames and best match indices selected from the codebook for the blocks of the second set of frames; and performing a bi-directional predictive coding process with respect to a third set of frames of the plurality of frames to obtain codes for respective blocks of the third set of frames, wherein each of the codes has an index-body determined using the best match indices for the blocks of the first and second sets of the frames and best match indices selected from the codebook for the blocks of the third set of frames.

The predictive coding process may include comparing patterns of the indices in the codebook with block patterns of the blocks of the second set of frames to select the best match indices for the blocks of the second set of frames; comparing a best match index of a block of the second set of frames with a best match index of a corresponding block of the first set of frames co-located with the second set of frames; determining the best match index of the corresponding block of the first set of frames to become an index-body of a code for the block of the second set of frames when the best match index of the block of the second set of frames is identical with the best match index of the corresponding block of the first set of frames; and determining a best match index selected from the codebook to become the index-body of the code for the block of the second set of frames when the best match index of the block of the second set of frames is different from the best match index of the corresponding block of the first set of frames.

The bi-directional predictive coding process may include comparing patterns of the indices in the codebook with block patterns of the blocks of the third set of frames to select the best match indices for the blocks of the third set of frames; determining whether a best match index of a block of the third set of frames is identical with a best match index of a corresponding block of the first set of frames; and determining whether the best match index of the block of the third set of frames is identical with a best match index of a corresponding block of the second set of frames.

The method of the present invention may further include producing base layer video data by decoding encoded video data using the decoding step; subtracting the base layer video data from original video data to obtain residual video data; encoding the residual video data using the intra-coding process, predictive coding process, and bi-directional predictive coding process; transmitting the encoded residual video data and the encoded video data to a decoder; decoding the encoded residual video data and the encoded video data using the intra-decoding process, predictive decoding process, and bi-directional predictive decoding process in the decoder; and compensating the decoded video data with the decoded residual video data.

In an aspect of the present invention, there is provided a method embedding a second codebook into a first codebook, which preferably includes (a) comparing a first vector of the second codebook with vectors in the first codebook; (b) selecting from the first codebook a vector closest to the first vector of the second codebook; (c) rearranging vectors of the first codebook to relocate the closest vector at a first position of the first codebook; (d) repeating steps (a), (b) and (c) with respect to each of second through last vectors of the second codebook; and (e) obtaining a rearranged codebook of which first part is a best approximation of the second codebook.

The CODEC system and method of the present invention is applicable to cellular telephone and network infrastructure, which generally have limited memory size and require lower computational complexity and power dissipation.

### BRIEF DESCRIPTION OF THE DRAWINGS

FIG. 1 is a block diagram of a CODEC system according to a preferred embodiment of the present invention;

FIG. 2 is a schematic diagram illustrating a vector quantization used in the CODEC system of the present invention;

FIG. 3 is a schematic diagram illustrating coding processes of the CODEC system of the present invention;

FIG. 4 is a flow chart for describing a predictive coding process of the present invention;

FIG. 5 is a flow chart for describing a bi-directional predictive coding process of the present invention;

FIG. 6 is a graphical diagram illustrating complexity and ratio of the data compression in the CODEC system of the present invention;

FIG. 7 is a schematic diagram for describing a CODEC method according to another embodiment of the present invention;

FIG. 8 is a flow chart for describing the CODEC method in FIG. 7;

FIG. 9 is a diagram for describing a codebook compression according to the present invention; and

FIG. 10 is a flow chart for describing the codebook compression of the present invention.

### DESCRIPTION OF PREFERRED EMBODIMENTS

Detailed illustrative embodiments of the present invention are disclosed herein. However, specific structural and functional details disclosed herein are merely representative for purposes of describing preferred embodiments of the present invention.

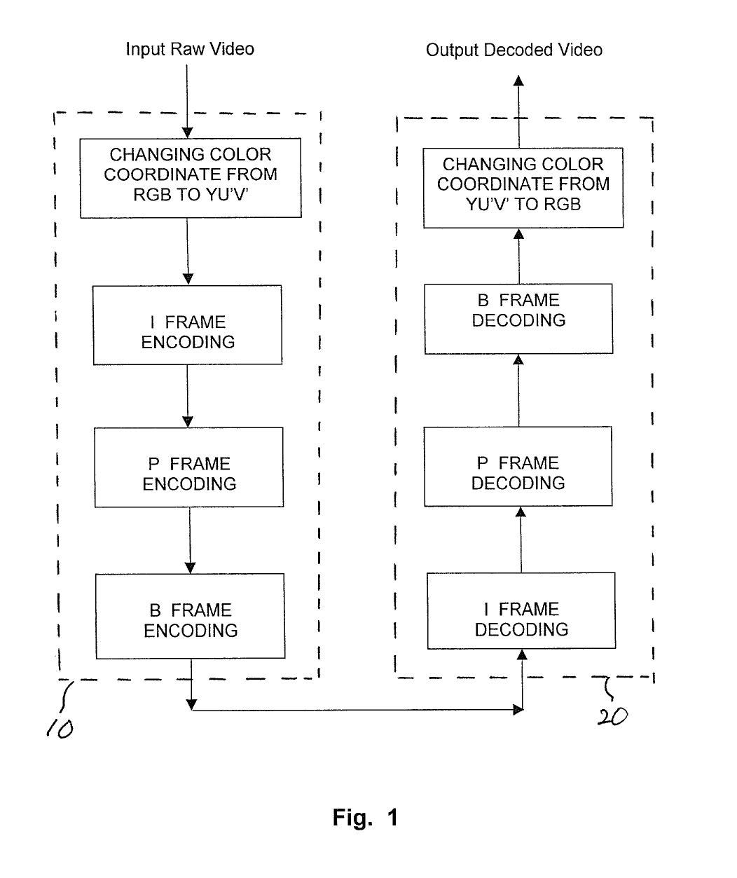

Referring to FIG. 1, there is provided a block diagram illustrating a CODEC (coder-decoder) system according to a preferred embodiment of the present invention. The CODEC for encoding data and decoding the encoded data employs very low bit-rate video coding-decoding technique and very low complex algorithm for the coding-decoding computation. The CODEC system in FIG. 1 includes an encoder 10 for encoding a video signal and a decoder 20 for receiving and decoding the encoded video signal. It should be noted that the signal provided to the CODEC system is not limited to a video signal. For example, a video signal with audio data can also be provided to the CODEC system and processed therein.

The encoder 10 receives a video signal having RGB (red, green, and blue) format. The encoder 10 changes the color coordinate of the video signal from the RGB format to YU′V′ format based upon the following formula:

Y=0.3077×R+0.6154×G+0.0769×B

U′=0.4615×R−0.4103×G−0.0513×B+128

V′=−0.1538×R−0.3077×G+0.4615×B+128

In the current international standards for video signals, “Y” represents luminance and “U/V” represent two color components. The present invention employs new Y/U′/V′ data that are computed from R/G/B and represent luminance and new color components having different color space compared with those of international standards.

The YU′V′ format is a video signal format specifically defined in the present invention to minimize the inverse conversion computation at the decoder. This is described in detail below.

In the encoder 10, the video signal with YU′V′ format is compressed using a data compress method according to the present invention. The data compress method of the present invention employs an intra-coding, predictive coding, and bi-directional coding, which are described in detail below.

The compressed video signal (or bit-stream) is generated from the encoder 10 to be stored in a data storage or transmitted to a video signal processing device via a transmission channel. The techniques of storing and transmitting video data are well known in the art, thus a detailed description thereof is omitted.

After receiving the bit-stream (i.e., compressed video signal) through a transmission channel, a decoder 20 decompresses the bit-stream using a data decompress method according to the present invention. The data decompress method is an inverse process of the data compress method of the present invention. Thus, the data decompress method of the present invention employs an intra-decoding, predictive decoding, and bi-directional decoding, which are described in detail below. In performing the decompression, the decoder does not perform any computation, but retrieve data based on index. Thus, the decoder can have a simple structure so that the CODEC system of the present invention has the low complexity.

Upon decompressing the bit-stream, the decoder 20 changes the color coordinate from YU′V′ format to RGB format based on the following formula:

R=Y+1.5×(U′−128)

G=−Y−0.75×(U′−128)−0.25×(V′−128)

B=Y+2×(V′−128)

As mentioned above, the inverse conversion computation at the encoder 20 is minimized, i.e., less complex than that in the conventional CODEC systems. This is because the inverse conversion computation is implemented by integer multiplications and shift operations. For example, “×=1.5y” can be implemented by “×=(384×y)>>8”. It is noted that integer point multiplications on RISC processors take much less cycles than floating point multiplications do.

The video signal with the RGB format is output from the decoder 20 and displayed in a display equipment.

Referring to FIGS. 1-3, a data compress method of the present invention will be described in detail. The data compression method basically includes three processes such as intra-coding, predictive coding, and bi-directional predictive coding.

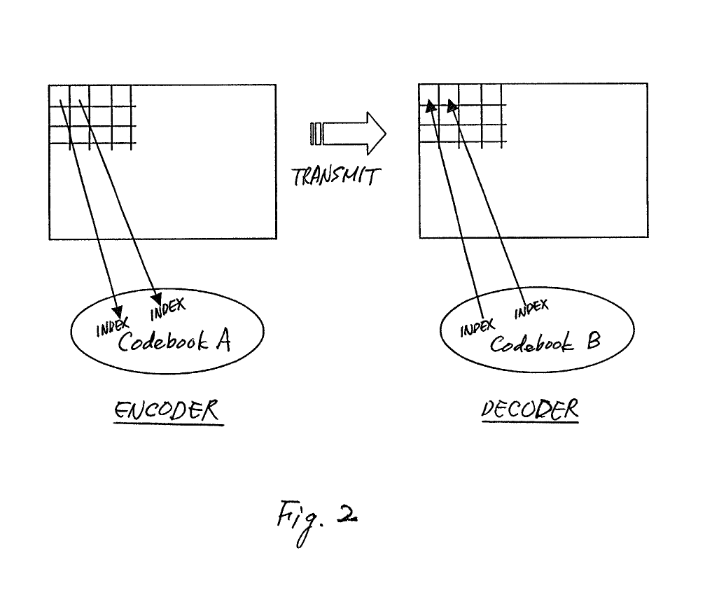

Intra-coding is a vector quantization applying to frames of a video signal input to the encoder 10. The intra-coding is performed with respect to certain frames (e.g., every 10th frame) of an input video clip. The frames on which the intra-coding is performed will be called “I-frames” for a convenience of the description. Each of the I-frames is broken into a predetermined number of blocks each of which also has a predetermined number of pixels. In FIG. 2, for example, each I-frame is broken into a number of blocks of each of which has “4×4” pixels. In this example, the size (i.e., width and height) of an input video clip may be any multiple of four (4) because each frame consists of 4×4 blocks.

The encoder has a codebook with which indices are stored. The indices represent various patterns of the 4×4 blocks. With respect to each I-frame, the encoder 10 compares a pattern of each block (i.e., a “block pattern”) with the indices in the codebook and selects an index best matching with the block pattern (i.e., a “best match index”). The encoder 10 finds the best match index for each and every 4×4 block of each I-frame. After finding the best match indices for the I-frames, the encoder 10 generates the best match indices to be transmitted to the decoder.

The best match indices are important part of compressed data to be transmitted to the decoder 20. Preferably, the compressed data is composed of header and index-body and the best match indices form the index-body.

It is noted that the decoder 20 has the same codebook as in the encoder so that the indices in the encoder and the decoder represent the same block patterns. Thus, when receiving the best match indices transmitted from the encoder, the decoder retrieves the block patterns corresponding to the best match indices in the codebook (Codebook B in FIG. 2).

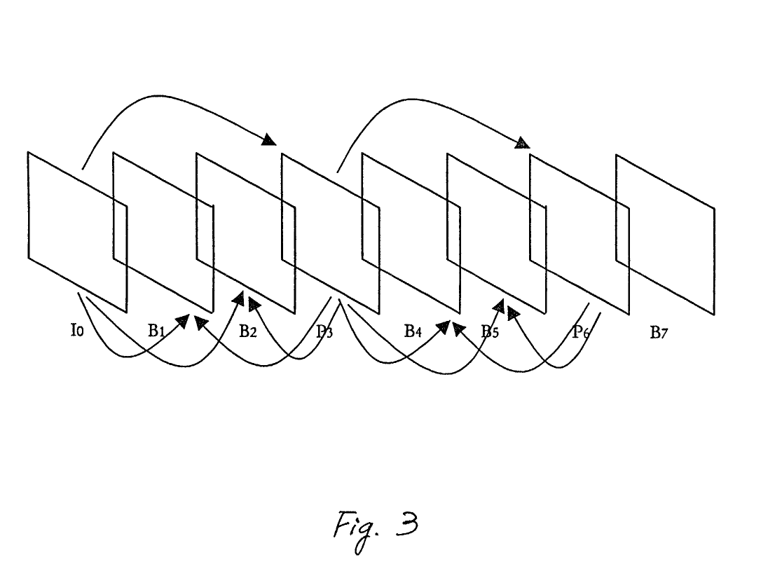

After performing the intra-coding, the decoder 20 performs a predictive coding (or predictive vector quantization). The predictive coding is performed with respect to a predetermined number of frames following an I-frame of an input video clip. For example, the predictive coding is performed with respect to every third frame P3, P6 following an I-frame 10, as shown in FIG. 3. The frames on which the predictive coding is performed will be called “P-frames” for a convenience of the description.

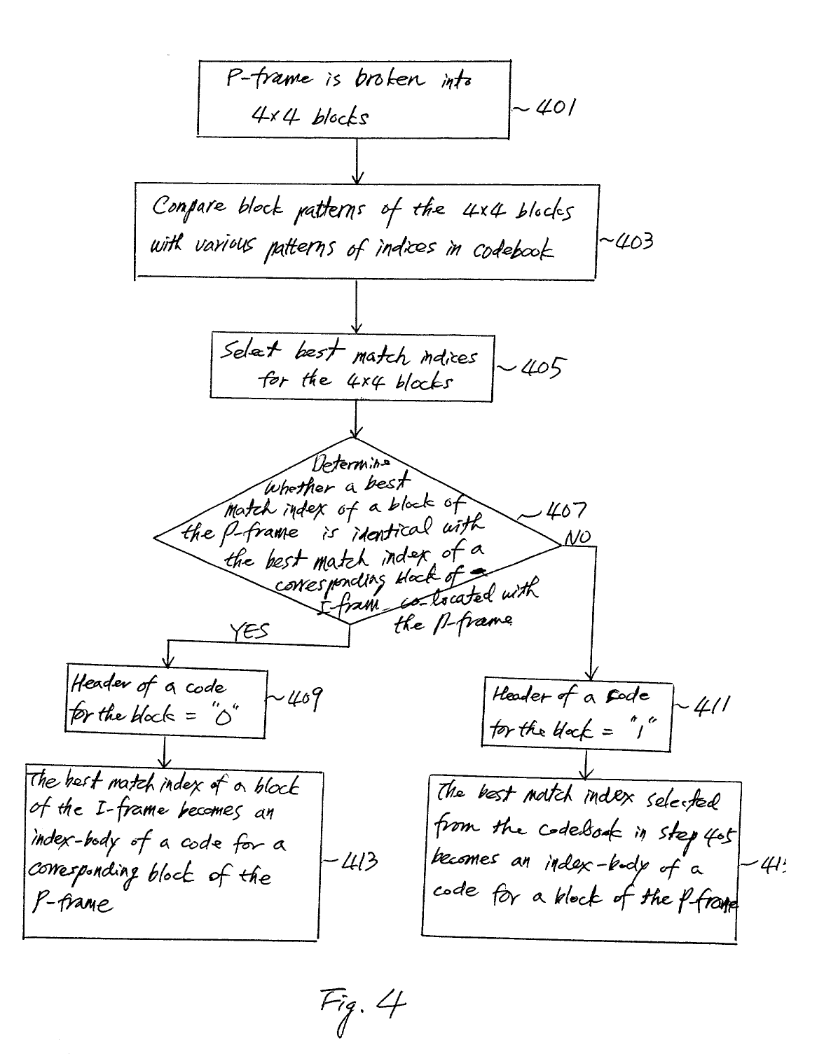

Referring to FIG. 4, there is provided a flow chart for describing a method of predictive coding according to the present invention. In a like manner as the I-frames, each of the P-frames is preferably broken into 4×4 blocks each of which has 4×4 pixels (step 401). The codebook (Codebook A) in the encoder 10 also contains indices representing various block patterns. The encoder 10 compares block patterns of a P-frame with the various patterns of the indices (step 403) to select an index representing a block pattern which is best matching with a block pattern of the P-frame (i.e., a best match index) (step 405). The encoder 10 performs the comparison and selection of the best match index with respect to each and every block of each P-frame.

By obtaining the best match indices for the respective blocks of the P-frames, codes will be determined for the respective blocks. A code for a block of a P-frame has an index-body and a header. The index-body of a code is determined by obtaining the best match index of a block of a P-frame. In other words, the best match index becomes the index-body of a code. The header of a code is determined by comparing the best match index of a block of a P-frame with that of a corresponding block of an I-frame which is co-located with the P-frame. In FIG. 3, the P-frames P3, P6 are co-located with the I-frame I0, and each of the best match indices of the 4×4 blocks of the P-frames P3, P4 are compared with a best mach index of a corresponding block of the I-frame 10.

To determine the header of a code for each block of the P-frame P3, a best match index of a block in the P-frame P3 is compared with a best match index of a corresponding block of the I-frame J0 to determine whether those two best match indices are identical (step 407). If they are identical, the header has a binary value, for example, “0” (step 409). If the two best match indices are different, the header has a binary value “1” (step 411). In this case, when the header is “0”, the best match index of a block of the co-related I-frame 10 becomes the index-body of a code of a corresponding block of the P-frame P3 (step 413). When the header is “1”, the index-body of a code for a block of the P-frame P3 is determined by finding a best match index for the block from the codebook (step 415). The header and index-body obtained through the predictive coding are transmitted to the decoder. Preferably, when the header is “0” (i.e., when the best match indices for the blocks of the I- and P-frames are identical), a code for the block of the P-frame has only the header to be transmitted to the decoder. Since such codes have only headers, the video data in the encoder can be further compressed.

The encoder also performs a bi-directional predictive coding (or a bi-directional predictive vector quantization). The bi-directional predictive coding is performed with respect to frames located between the I-framne IO and the P-frames P3, P6. The frames on which the bi-directional predictive coding is performed will be called “B-frames” for a convenience of the description.

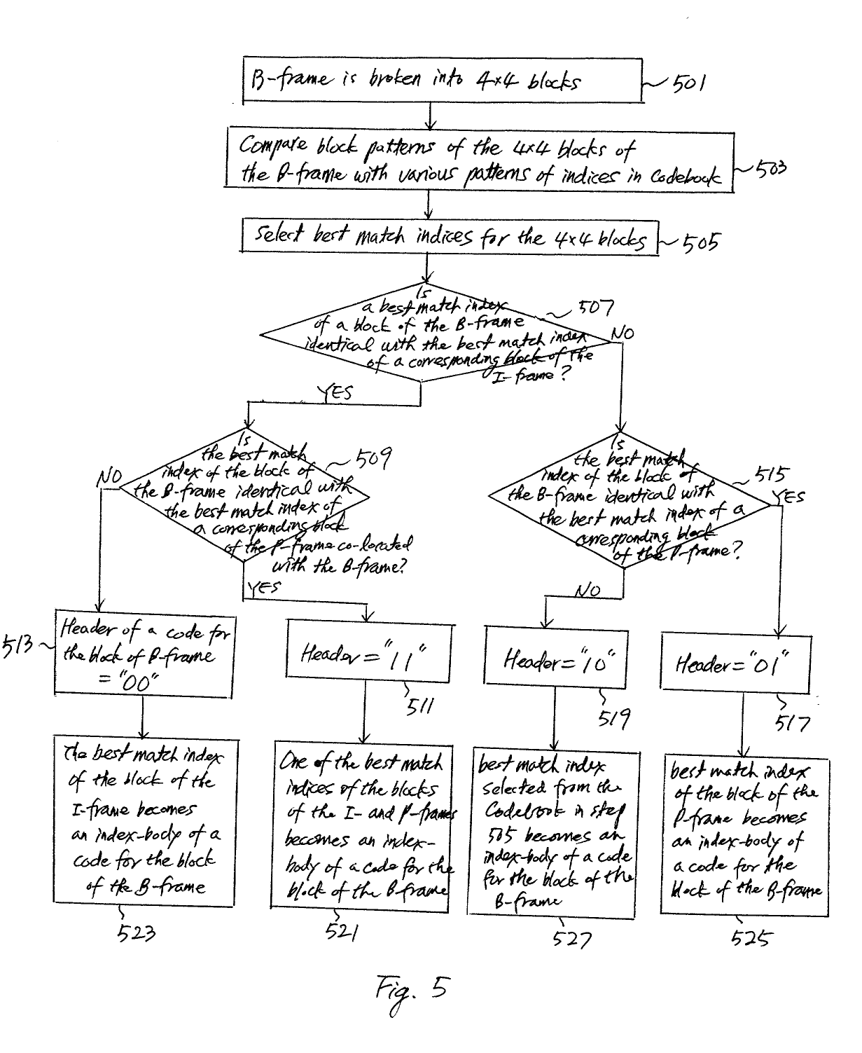

FIG. 5 shows a flow chart for describing the bi-directional predictive coding according to the present invention. Each of the B-frames is also broken into 4×4 blocks (step 501). With respect to each B-frame, the encoder finds the best match index for each and every 4×4 block using the same manner as for the I-frames and the P-frames (steps 503 and 505). A code for a 4×4 block obtained through the bi-directional predictive coding has also a header and an index-body. In a like manner as in the predictive coding, the header has a binary value by determining whether the best match index of a block of a B-frame is identical with that of a corresponding block of an I-frame and/or a P-frame.

With respect to the B-frame B1 (referring to FIG. 3), the encoder finds the best match index of a 4×4 block from the codebook and compares the best match index with that of a corresponding block of the I-frame 10 co-located with the B-frame B1 (step 507). If those two best match indices are identical, it is determined if the best match index of the block in the B frame B1 is identical with that of a corresponding block in the P-frame P3 (step 509). If the best match index of the block in the B-frame B1 is identical with those of corresponding blocks in the I-frame I.0 and the P-frame P3 which are co-located with the B-frame B1, the header of a code for the block of the B-frame B1 has 2-bit binary value, for example, “11” (step 511 ). If the best match index of the block in the B-frame B1 is identical with that of the corresponding block of the I-frame I.0 but not with that of the block of the P-frame P3, the header has value “00” (step 513).

If the best match index of the B-frame B1 is not identical with that of the I-frame I.0 in step 507, it is also determined if the best match index of the block in the B-frame B1 is identical with that of the block in the P-frame P3 (step 515). If the best match index of the B-frame B1 is not identical with that of the I-frame 10 but identical with that of the P-frame P3, the header of the code for the block of the B-frame B1 has value “01” (step 517). If the best match index of the B-frame B1 is not identical with both the best match indices of the I- and P-frames 10, P3, the header has value “10” (step 519).

Once the header is determined, an index-body of the code for the block of the B-frame B1 is determined based on the value of the header. When the header has value “11”, one of the best match indices of the I- and P-frames IO, P3 becomes the index-body of the code (step 521). When the header has value “00”, the best match index of the I-frame I0 becomes the index-body of the code (step 523). When the header has value “01”, the best match index of the P-frame P3 becomes the index-body of the code (step 525). When the header has value “10” (i.e., the best match index of the B-frame B1 is different from those of the I- and P-frames IO, P3), the best match index of the block selected from a codebook in step 505 becomes the index-body of the code (step 527).

Thus, when the header of a code for a block in the B-frame B1 is “00”, “01” or “11”, the index-body of the code has the same index as that of a corresponding block of the I-frame IO or the P-frame P3, while the encoder finds a new best match index from the codebook for the index-body when the header is “10”.

The encoder then generates the codes (i.e., headers and index-bodies) for the blocks of the B-frame B1 to be transmitted to the decoder. Preferably, when the header is “00”, “01” or “11”, a code to be transmitted to the decoder has only the header. In other words, only the header for the block in the B-frame B1 is transmitted to the decoder, and the best match index of the block is obtained in the decoder by copying that of a corresponding block of the I- or P-frame co-located with the B-frame B1.

The headers for the blocks of each B-frame constitute a 2-bit array of which size is equal to the number of 4×4 blocks in the frame. Preferably, the first part of compressed bit stream output from the encoder has a set of 2-bit array.

Referring again to FIG. 1, upon receiving the bit-stream, i.e., the data coded based on the intra-coding, predictive coding and bi-directional predictive coding in the encoder, the decoder 20 performs a decompression process with respect to the bit-stream. The decompression of the bit-stream includes intra-decoding, predictive decoding and bi-directional predictive decoding which are inverse processes of the intra-coding, predictive coding and bi-directional predictive coding.

For the I-frames, the decoder reads the best match indices from the compressed bitstream and retrieves block vector data (i.e., block patterns) from a pre-defined codebook which has the same contents as that of the codebook in the encoder. After decoding the I-frames, P-frames co-located with the I-frames are decoded. The decoder copies part of data from a previous I-frame into a current P-frame based on header information. For the rest of the P-frame, decoder reads best match indices from the index-bodies of the bitstream and retrieves block vector data from the codebook to complete an entire P-frame. After decoding P-frames, B-frames co-located with the P-frames are decoded. The decoder copies part of data from previous I- and P-frames into a current B-frame based on header information. For the rest of the B-frame, decoder reads best match indices from the index-bodies of the bitstream and retrieves block vector data from the codebook to complete an entire B-frame.

Upon decompressing the bit-stream, the decoder changes color coordinate of the video signal from the YU′V′ format to the RGB format.

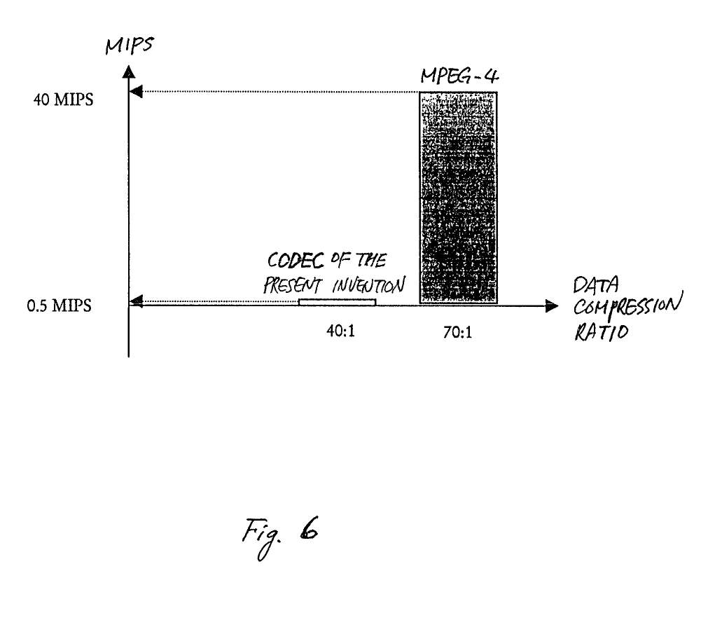

Referring to FIG. 6, there is provided a graphical diagram illustrating complexity and ratio of the data compression. As shown in FIG. 6, the CODEC system of the present invention is optimized for the low complex computation and low power consumption. MIPS is a unit to measure computation to do a certain job in a CODEC system. As shown in FIG. 6, it takes 0.5 MIPS to decode a frame worth of the compressed bitstream in the CODEC system of the present invention, while it takes 20-40 MIPS to decode a frame worth of MPEG-4 compressed bitstream. This measure could vary based on different flatforms and source codes. For example, typical computational power on hand phone is less than 1-2 MIPS. Thus, the conventional CODEC systems, such as MPEG-4 decoder cannot finish a frame decoding for 20-40 seconds.

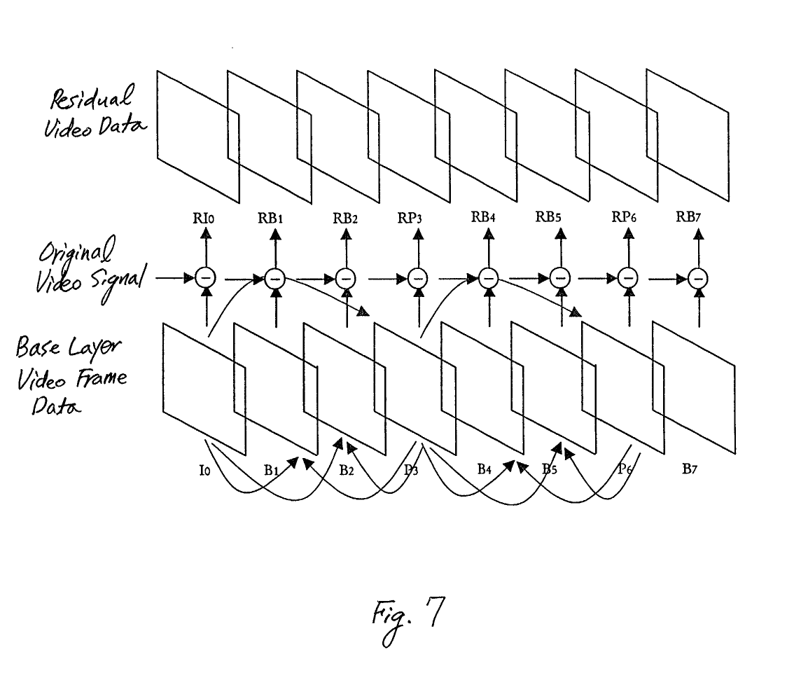

Referring to FIG. 7, there is provided a schematic diagram for illustrating another embodiment of the CODEC system according to the present invention. In this embodiment, an encoder of the CODEC system performs the data compression with respect to residual video data which is obtained from the difference between the original video signal and a reconstructed video signal. The residual video data is used for compensating errors which may be caused at the time of encoding and decoding the video data.

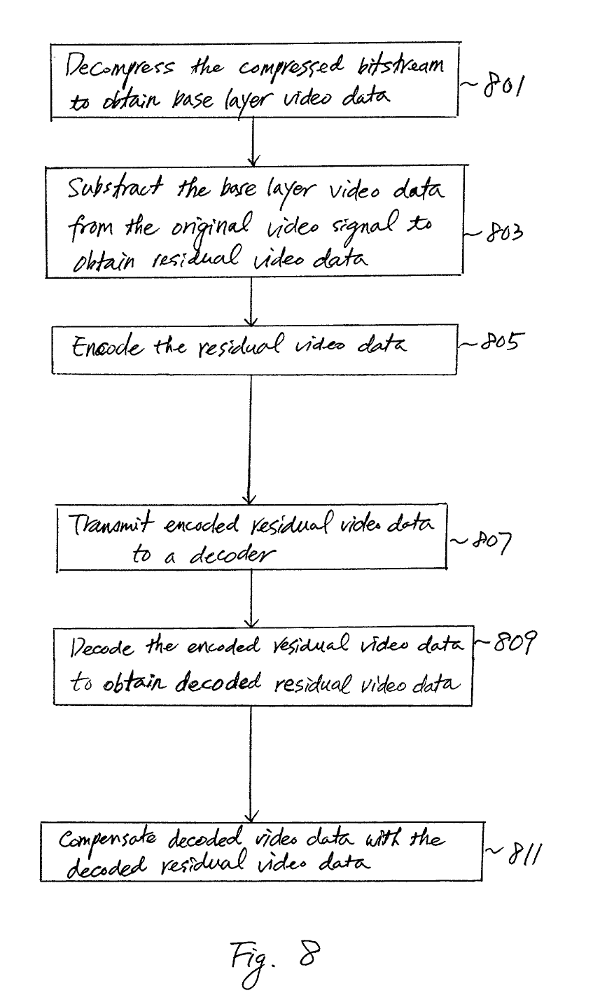

Referring to FIG. 8, the compressed bit stream by using the above described algorithms is decompressed to obtain base layer video data (step 801). The base layer video data is then subtracted by the original video signal to obtain the residual video data (step 803). The residual video data is then encoded by using the algorithms of the present invention (step 805). The encoding of the residual video data is preferably performed using only the intra-coding process. The steps of decompressing (step 801), subtracting (step 803) and encoding (step 805) are performed in the encoder. The encoded residual video data is transmitted to the decoder (step 807).

Upon receiving the transmitted data, the decoder decodes the encoded residual video data to obtain decoded residual video data (step 809). At this time, the decoder preferably uses the intra-decoding algorithm. The decoder also decodes the base layer video data transmitted from the encoder, and compensates the decoded base layer video data with the decoded residual video data (step 811).

When encoding the residual video data frames (or “R-frames” in FIG. 7), the encoder performs a residual coding with respect to each of the R-frames of an incoming video clip. In the residual coding, each R-frame is broken into blocks each having 4×4 blocks. The encoder has a residual codebook containing indices representing various residual patterns. The encoder compares the pattern of a block in a R-frame with the various residual patterns in the residual codebook and finds a residual pattern best matching the pattern of the block. Then, an index of the residual pattern is determined as a best match index of the block in the R-frame. In a like manner, the encoder finds best match indices for each and every blocks in each R-frame.

The best match indices obtained through the residual coding are transmitted to the decoder. Since the decoder also has the same residual codebook as in the encoder, the decoder retrieves the residual patterns corresponding to the best match indices received from the encoder.

Preferably, a code obtained through the residual coding with respect to a block of a R-frame has a header and an index-body. The header of a code for a block has a binary value which is determined by comparing sum of absolute difference (SAD) of the block with a given threshold value. The SAD may be a sum of absolute magnitude of each pixel in the block. If the SAD is larger than the threshold value, the header has binary value, for example, “1”. In this case, the encoder finds a new best match index for the block of a R-frame from the residual codebook, and the new best match index becomes the index-body of the code. If the SAD is equal to or less than the threshold value, the header has binary value “0”. In this case, there is no index-body of the code corresponding to the present block. In other words, if there is a block that does not have an index-body, simply no residual error is added to the block. Thus, the encoded residual video data is further compressed through the residual coding of the present invention. The headers of the blocks in each R-frame preferably constitute a binary array of which size is the number of the blocks in the R-frame.

The codes of the blocks in each R-frame are transmitted to the decoder which then retrieves the residual patterns corresponding to the best match indices as described above.

The compression of video data using the SAD measurement may be used, especially, for very low bitrate (or very low complexity) video coding technology, for example, CDMA (about 14Kbps), GSM (about 9Kbps) and GPRS (about 20Kbps) wireless handphone sets.

As described above, the encoder and decoder used in the CODEC system of the present invention has the same codebook containing a number of indices. Thus, the encoder and decoder each require a memory device to store the indices. To make the size of the memory device smaller, the CODEC system of the present invention employs a compressed codebook. In other words, in the CODEC system of the present invention, the codebook in the encoder and decoder is compressed to save the memory for the codebook.

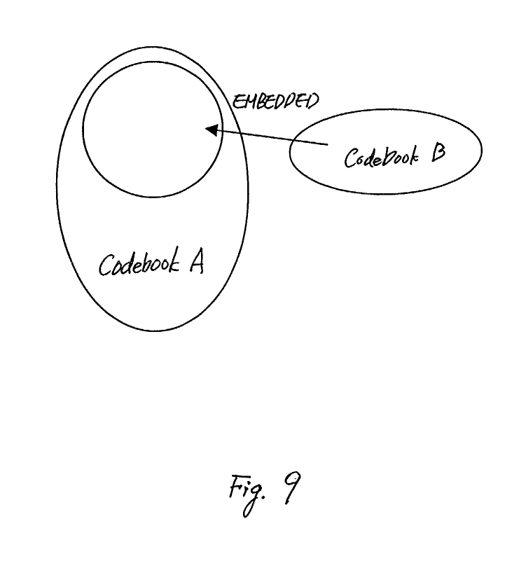

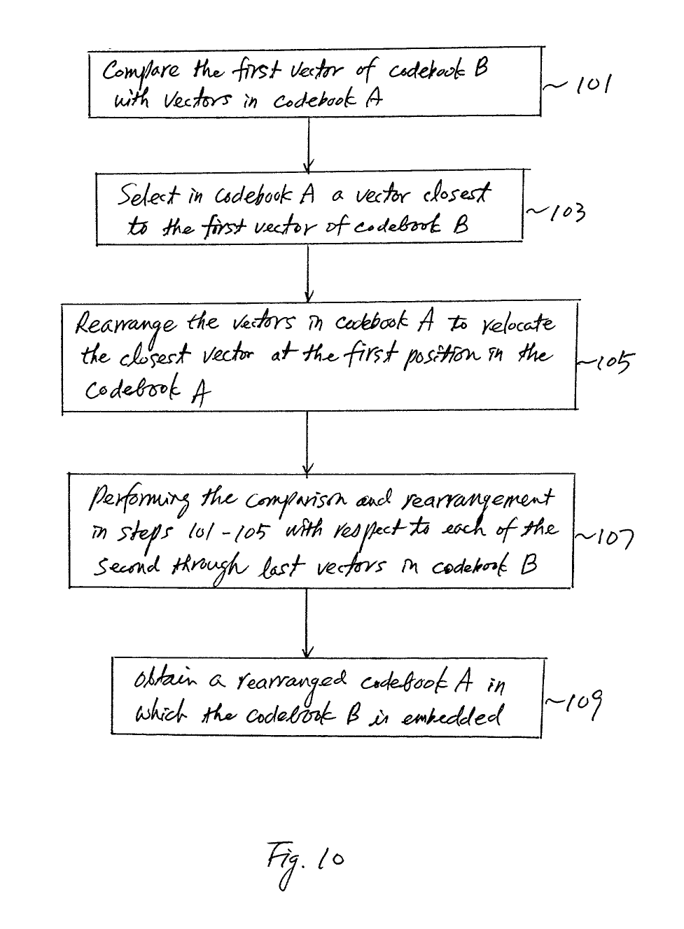

Referring to FIGS. 9 and 10, there are provided a schematic diagram and a flow chart for describing the compression of a codebook to be used in the CODEC system of the present invention. Assuming that codebook A (e.g., 1024 vectors) has a bigger size than that of codebook B (e.g., 512 vectors), the codebook B is embedded into the codebook A, so that the codebooks A and B are compressed into a rearranged codebook A.

Referring to FIG. 10, vectors of the codebook A are rearranged in the following manner. A first vector in the codebook B is selected and compared with the vectors in the codebook A (step 101). Of the vectors in the codebook A, a vector closest to the first vector of the codebook B is selected (step 103). Upon finding the closest vector, the vectors of the codebook A are rearranged so that the closest vector is relocated as the first vector of the codebook A (step 105). Then, a second vector is selected in the codebook B, and the vectors in the codebook A are compared with the second vector to find a vector closest to the second vector. The vectors of the codebook A are again rearranged so that the vector closest to the second vector of the codebook B is relocated as the second vector of the codebook A. The vectors of the codebook A are repeatedly compared and rearranged until finding the vector closest to the last vector of the codebook B and relocating the closest vector as the last vector of the codebook A (step 107). By performing such an iterative reallocation, the first part of the rearranged codebook A becomes the best approximation of the codebook B (step 109).

Such a codebook compression technique is applicable when two or more codebooks are requested for a CODEC system. For example, to compress three color component data (Y/U/V) requires three different codebooks in both encoder and decoder sides. In this case, a codebook for U or V component can be embedded into a codebook for Y component. In case that the codebook for U component is embedded into the codebook for Y component, the embedded codebook (i.e., the first part of the codebook for Y component) is used for data compression of the U component data, while the entire codebook is still used for data compression of the Y component data. Thus, the same codebook is used for data compression of both the U and Y component data.

Having described preferred embodiments of a system and method for coding and decoding video data according to the present invention, modifications and variations can be readily made by those skilled in the art in light of the above teachings. It is therefore to be understood that, within the scope of the appended claims, the present invention can be practiced in a manner other than as specifically described herein.

what is claimed is:

1. A method for encoding video data, comprising the steps of:
providing video data having a plurality of frames each of which has a plurality of blocks, each block having a predetermined number of pixels;
providing a codebook having indices each representing a different pattern;
performing an intra-coding process with respect to a first set of frames of the plurality of frames to select from the codebook best match indices for respective blocks of the first set of frames;
performing a predictive coding process with respect to a second set of frames of the plurality of frames to obtain codes for respective blocks of the second set of frames, wherein each of the codes has an index-body determined using the best match indices for the blocks of the first set of frames and best match indices selected from the codebook for the blocks of the second set of frames; and
performing a bi-directional predictive coding process with respect to a third set of frames of the plurality of frames to obtain codes for respective blocks of the third set of frames, wherein each of the codes has an index-body determined using the best match indices for the blocks of the first and second sets of the frames and best match indices selected from the codebook for the blocks of the third set of frames.

2. The method of claim 1, wherein the second set of frames are selected from frames located between adjacent frames of the first set of frames.

3. The method of claim 2, wherein the third set of frames are selected from frames located between adjacent frames of the second set of frames or adjacent frames of the first and second sets of frames.

4. The method of claim 1, wherein the predictive coding process includes the steps of:
comparing patterns of the indices in the codebook with block patterns of the blocks of the second set of frames to select the best match indices for the blocks of the second set of frames;
comparing a best match index of a block of the second set of frames with a best match index of a corresponding block of the first set of frames co-located with the second set of frames;
determining the best match index of the corresponding block of the first set of frames to become an index-body of a code for the block of the second set of frames when the best match index of the block of the second set of frames is identical with the best match index of the corresponding block of the first set of frames; and
determining a best match index selected from the codebook to become the index-body of the code for the block of the second set of frames when the best match index of the block of the second set of frames is different from the best match index of the corresponding block of the first set of frames.

5. The method of claim 4, further including setting a header of the code for the block of the second set of frames with a binary value which varies depending on whether the best match index of the block of the second set of frames is identical with the best match index of the corresponding block of the first set of frames.

6. The method of claim 5, wherein the code for the block of the second set of frames has the header and the index-body when the best match index of the block of the second set of frames is different from the best match index of the corresponding block of the first set of frames.

7. The method of claim 6, wherein the code for the block of the second set of frames has only the header when the best match index of the block of the second set of frames is identical with the best match index of the corresponding block of the first set of frames.

8. The method of claim 1, wherein the bi-directional predictive coding process includes the steps of:
comparing patterns of the indices in the codebook with block patterns of the blocks of the third set of frames to select the best match indices for the blocks of the third set of frames;
determining whether a best match index of a block of the third set of frames is identical with a best match index of a corresponding block of the first set of frames; and
determining whether the best match index of the block of the third set of frames is identical with a best match index of a corresponding block of the second set of frames.

9. The method of claim 8, further including determining the best match index of the corresponding block of the first set of frames to become an index-body of a code for the block of the third set of frames when the best match index of the block of the third set of frames is identical with the best match index of the corresponding block of the first set of frames and different from the best match index of the corresponding block of the second set of frames.

10. The method of claim 9, further including determining the best match index of the corresponding block of the second set of frames to become the index-body of the code for the block of the third set of frames when the best match index of the block of the third set of frames is identical with the best match index of the corresponding block of the second set of frames and different from the best match index of the corresponding block of the first set of frames.

11. The method of claim 10, further including determining the best match index of the corresponding block of the first set of frames or the best match index of the corresponding block of the second set of frames to become the index-body of the code for the block of the third set of frames when the best match index of the block of the third set of frames is identical with the best match index of the corresponding block of the first set of frames and the best match index of the corresponding block of the second set of frames.

12. The method of claim 11, further including determining a best match index selected from the codebook for the block of the third set of frames to become the index-body of the code for the block of the third set of frames when the best match index of the block of the third set of frames is different from both the best match indices of the corresponding blocks of the first and second sets of frames.

13. The method of claim 12, further including setting a header of the code for the block of the third set of frames with a binary value which varies depending on whether the best match index of the block of the third set of frames is identical with, either one of or both, the best match index of the corresponding block of the first set of frames and the best match index of the corresponding block of the second set of frames.

14. The method of claim 13, wherein the code for the block of the third set of frames has the header and the index-body when the best match index of the block of the third set of frames is different from both the best match indices of the corresponding blocks of the first and second sets of frames.

15. The method of claim 14, wherein the code for the block of the third set of frames has only the header when the best match index of the block of the third set of frames is identical with, either one of or both, the best match index of the corresponding block of the first set of frames and the best match index of the corresponding block of the second set of frames.

16. The method of claim 1, further including embedding a second codebook into the codebook, wherein the embedding step including the steps of:
(a) comparing a first vector of the second codebook with vectors in the codebook;
(b) selecting from the codebook a vector closest to the first vector of the second codebook;
(c) rearranging vectors of the codebook to relocate the closest vector at a first position of the codebook;
(d) repeating steps (a), (b) and (c) with respect to each of second through last vectors of the second codebook; and
(e) obtaining a rearranged codebook of which first part is a best approximation of the second codebook.

17. The method of claim 16, wherein the codebook is used for encoding a first component of the video data and the second codebook is used for encoding a second component of the video data.

18. The method of claim 1, further including changing color coordinate of the video data from RGB format to YU′V′ format using formula as follows:
Y=0.3077×R+0.6154×G+0.0769×B
U′=0.4615×R−0.4103×G−0.0513×B+128
V′=−0.1538×R×−0.3077×G+0.4615×B+128

19. The method of claim 1, further including decoding codes encoded by the method for encoding video data, the decoding step including the steps of:
performing an intra-decoding process with respect to codes for blocks of the first set of frames, wherein the intra-decoding process includes reading best match indices from index-bodies of the codes for the blocks of the first set of frames and retrieving block patterns from a codebook based on the best match indices;
performing a predictive decoding process with respect to codes for blocks of the second set of frames, wherein the predictive decoding process includes reading best match indices from index-bodies of the codes for the blocks of the second set of frames or from index-bodies of the codes for the blocks of the first set of frames based on header information of the codes for the blocks of the second set of frames; and
performing a bi-directional predictive decoding process with respect to codes for blocks of the third set of frames, wherein the bi-directional predictive decoding process includes reading best match indices from index-bodies of the codes for the blocks of the third set of frames, from index-bodies of the codes for the blocks of the second set of frames, or from index-bodies of the codes for the blocks of the first set of frames based on header information of the codes for the blocks of the third set of frames.

20. The method of claim 19, further including changing color coordinate of the video data from YU′V′ format to RGB format using formula as follows:
R=Y+1.5×(U′−128)
G=Y−0.75×(U′″128)−0.25×(V′−128)
B=Y+2×(V′−128)

21. The method of claim 19, further including the steps of:
producing base layer video data by decoding encoded video data using the decoding step;
subtracting the base layer video data from original video data to obtain residual video data;
encoding the residual video data using the intra-coding process;
transmitting the encoded residual video data and the encoded video data to a decoder;
decoding the encoded residual video data and the encoded video data using the intra-decoding process, predictive decoding process, and bi-directional predictive decoding process in the decoder; and
compensating the decoded video data with the decoded residual video data.

22. The method of claim 21, wherein the step of encoding the residual video data includes obtaining codes for blocks of frames of the residual video data, the code-obtaining step includes the steps of:
comparing a sum of absolute difference (SAD) of each block of the frames of the residual video data with a predetermined threshold value;
a header of a code for each block has a first value when the SAD is larger than the predetermined threshold value; and
the header has a second value when the SAD is equal to or smaller than the predetermined threshold value.
